(19) United States
(12) Patent Application Publication
(10) Pub. No.: US 2015/0102223 A1
(43) Pub. Date: Apr. 16, 2015

(54) DISPERSION SPECTROMETER

(71) Applicant: Nils Wihlborg, Helsingborg (SE)

(72) Inventor: Nils Wihlborg, Helsingborg (SE)

(73) Assignee: FOSS ANALYTICAL AB, Hoganas (SE)

(21) Appl. No.: 14/382,381

(22) PCT Filed: Mar. 14, 2012
(86) PCT No.: PCT/EP2012/054441

§ 371 Date: Sep. 2, 2014

(51) Int. Cl. G01J 3/02; G01J 3/28

(52) U.S. Cl. CPC G01J 3/0205; G01J 3/28
USPC 250/339.02

(57) ABSTRACT

A dispersion spectrometer comprises a wavelength dispersive element located within a path of incoming radiant energy; and a first detector disposed to detect incoming radiant energy dispersed by the dispersive element, The spectrometer further comprises a second detector disposed to register the intensity of at least a portion of the un-dispersed incoming radiation and configured to generate a signal representative of the registered intensity, the first detector being adapted to have operational parameters in the form of integration time and/or sensitivity gain varied in response to the signal.

The present invention relates to a dispersion type spectrometer and in particular to a spectrometer having an addressable array of detection elements.

Dispersion type spectrometers are well known in the art and are typically employed in the investigation of material properties through monitoring wavelength dependent intensity variations of radiant energy after its interaction with the material. These spectrometers generally comprise a wavelength dispersive element located within a path of incoming radiant energy and a detector disposed to detect incoming radiant energy dispersed by the dispersive element.

Depending on the intended application of the spectrometer the incoming radiant energy will consist of some or the entire portion of the electromagnetic spectrum from and including ultra-violet to and including the infra-red and radiant energy will be used throughout this document as referring to this.

The dispersive element typically is a static or movable diffraction grating which itself may be either a transmission grating or a reflection grating.

The detector may be any light sensitive detector know to be employed in such spectrometers and may be, for example, a photomultiplier tube, a photo-sensitive semi-conductor device, an addressable array of detection elements such as a photo-diode array, for example a CMOS or NMOS array, or a charge coupled device. A common feature with all these detectors is that they have operational parameters (integration time and/or sensitivity gain) which are adjustable to change characteristics of the output signal of the detector which is generated in response to the detected radiant energy.

The above mentioned operational parameters often need to be adjusted during the operation of the spectrometer in order to correct for changes in intensity of incoming radiant energy due to variations in the material being investigated using the spectrometer. Whether manually or by automation, the known adjustment procedure generally follows a recursive algorithm by which the parameter being adjusted is varied stepwise by a known amount, a measurement made on the material, the signal at the detector monitored and a decision whether or not to continue the adjustment is made based on the signal. This may be repeated many times until a desired signal characteristic (typically the signal to noise ratio ‘S/NI’) is achieved.

A problem with this known adjustment procedure is that during the procedure no investigations may be performed. This is a particular problem when the material being investigated is moving, either the movement should be halted or amounts, often substantial amounts of material, will not be investigated. An additional problem with this ‘trial and error’ approach is that the detector may become inadvertently saturated which results in a certain recovery time then being needed in order to have the detector revert to a usable state before the adjustment procedure can be continued. This is a particular problem in addressable array type detectors where ‘blooming’ occurs when the charge in a pixel of the array exceeds the saturation level and the charge starts to fill adjacent pixels. Another problem occurs when the intensity of incoming radiant energy is relatively low, the intensity of the dispersed energy is correspondingly even lower which leads to the necessity of longer integration times and hence larger delays in making investigations.

It is the aim of the present invention to at least mitigate the above mentioned problems.

Accordingly there is provided a dispersion spectrometer comprising a wavelength dispersive element located within a path of incoming radiant energy; a first detector disposed to detect incoming radiation dispersed by the dispersive element and a second detector configured to register at least a portion of the incoming radiation without dispersion and is configured to generate a signal dependent on the registered intensity which is used in the spectrometer to adjust one or more operational parameters of the first detector. In this manner the first detector is not used in the adjustment procedure and so the possibility of saturating the first detector during the procedure is significantly reduced, even removed. Moreover, since a second detector detects radiant energy before its dispersion and onward propagation to the first detector the first detector may be adjusted in substantially ‘real-time’ thus reducing the time the spectrometer unavailable for making measurements during its operation. Additionally, the measurement before dispersion provides a substantially larger intensity of radiant energy at the second detector than at the first, improving the sensitivity and speed of these control measurements compared with the post-dispersion measurements employed in the known spectrometers.

These and other advantages of the present invention will become apparent from a consideration of the following description of an exemplary embodiment which is made in connection with the drawings of the following figures of which:

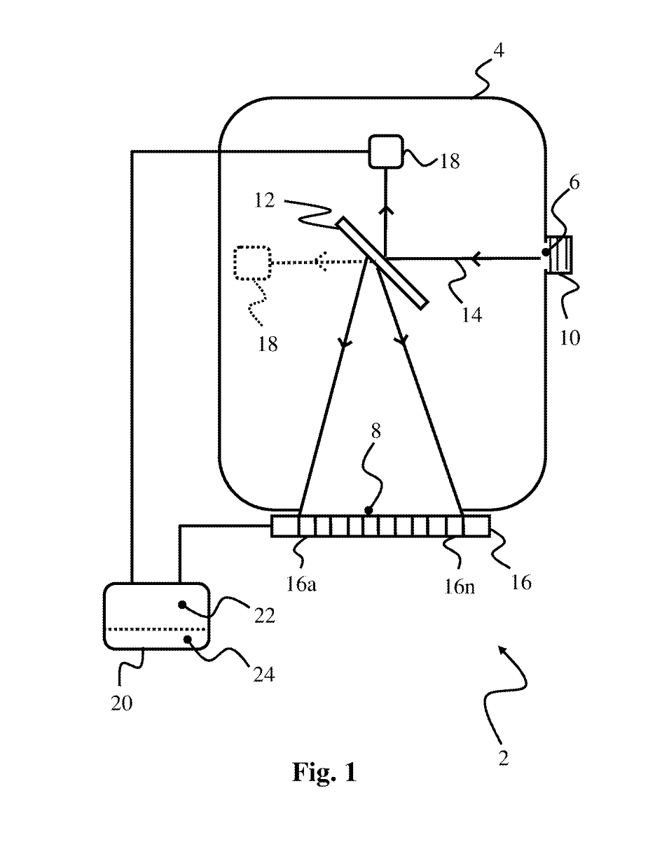

FIG. 1: shows a schematic partial representation of a spectrometer according to the present invention.

With reference to FIG. 1, elements of a dispersion spectrometer 2 which are relevant to an understanding of the present invention are shown. A housing 4 is provided having an entrance aperture 6 and an exit aperture 8. In the present embodiment the entrance aperture 6 is provided with a coupling 10 (illustrated as a threaded coupling) for connecting the entrance aperture 6 to a fiber-optic (not shown) for providing radiant energy at the entrance aperture 6.

A dispersive element, here in the form of a fixed transmission grating 12, is disposed in the path (illustrated by arrowed line 14) of incoming radiant energy through the housing 4. A first detector is coupled to the exit aperture 8 in order to detect incoming radiant energy after its wavelength dependent dispersion by the grating 12. A second detector 18 is disposed to register the intensity of the incoming radiant energy before dispersion and to generate an output signal representing this intensity. The second detector 18 is, in the present embodiment, arranged within the housing 4 to register incoming radiant energy which is reflected from the grating 12. It will be appreciated that according to the well known Fresnel equations the relative amounts of radiant energy reflected and transmitted at the grating 12 will effectively remain constant with change in wavelength for a fixed geometry. In the present embodiment, in which the grating 12 is formed on a glass substrate and is disposed at an angle of 45° to the path of incident radiation 14 from the entrance aperture 6, the reflected portion will be around 10% of the incoming radiant energy. In an alternative arrangement (illustrated by the broken line construction in FIG. 1) the second detector 18 may be disposed to monitor the zero order diffraction signal (i.e. the non-dispersed radiant energy) from the grating 12.

In the present embodiment, and by way of example only, the spectrometer 2 is intended for use in monitoring incoming near infra-red radiation. The first detector 16 is an addressable array, here an individually addressable linear array of NMOS detector elements 16a . . . 16n. Each element, or ‘pixel’ of the array may be considered to be a separate capacitor which is capable of holding a charge, the size of which is dependent on both the intensity of the incident radiation and on the time for which the charge is allowed to build before the capacitor is discharged. This time may be considered an ‘integration time’ of the first detector 16. In the present configuration of the spectrometer 2 each element of the array 16a . . . n is exposed to a different narrow wavelength band of the incoming radiant energy that has been wavelength dispersed by the element 12.

The second detector is an IR detector, such as a silicon detector, which is configured to generate an output signal proportional to the intensity of registered radiant energy, in this example a signal having a frequency that is linearly proportional to the radiance. It will however be appreciated that the selection of first and second detectors depends on the intend use of the spectrometer.

A controller 20 is provided as an element of the spectrometer 2 in operable connection to both the first detector 16 and the second detector 18 to receive input from the second detector 18 and to generate an output in response to this input for control of the operation of the first detector 16, particularly control of the operational parameters associated with the first detector 16 and in the present embodiment the control of the integration time of the detector array 16a . . . n. It will be appreciated that other embodiments may be configured with a controller 20 adapted to control the gain of a detector 16 based on the input received from the second detector 18 in addition or as an alternative to the integration time.

The controller 20, in the present embodiment, comprises a data processing portion 22 and a memory portion 24 which is accessible by the data processing portion 22 and which holds an algorithm for linking the intensity of the radiant energy registered by the second detector 18 with an intensity dependent desired value of an operating parameter of the first detector 16. This algorithm may, for example, represent a mathematical equation linking the two or may represent a ‘look-up’ algorithm for data held in the memory portion 24 which represents desired values indexed against intensity values. In the present embodiment the algorithm represents an equation which links the input intensity to a desired integration time in an inverse, linear relationship (the greater the intensity registered at the second detector 16 the smaller the integration time).

The data processing portion 22 is adapted to receive the output from the second detector 18 and extract from this a value representative of the intensity of radiant energy registered by the detector 18. In the present embodiment this may be a value indicative of the frequency of the signal from the detector 18. The data processing portion 22 then operates to apply the algorithm stored in the memory portion 24 to the extracted value in order to determine a desired integration time for the first detector 16 which is then employed in the control of the first detector 16. In the present embodiment a control signal is generated periodically by the controller 20 that is input to the first detector 16 which in turn responds by initiating an discharging (or emptying) of each pixel element of the array 16a . . . n. The period of generation being set to correspond to the desired integration time as determined in the data processing portion 22 from the registered intensity of the radiant energy as described above.

1. A dispersion spectrometer comprising:
a wavelength dispersive element located within a path of incoming radiant energy;
a first detector configured to detect the incoming radiant energy dispersed by the wavelength dispersive element; and
a second detector configured to register an intensity of at least a portion of the incoming radiant energy without dispersion and configured to generate a signal representative of the registered intensity, and the first detector is configured to have operational parameters varied in response to the signal.

2. The dispersion spectrometer as claimed in claim 1, wherein the first detector is configured to have varied one or both of an integration time or a sensitivity gain of the first detector as the operational parameters.

3. The dispersion spectrometer as claimed in claim 2, wherein the first detector comprises a photodiode array configured to have varied the integration time of array elements of the photodiode array.

4. The dispersion spectrometer as claimed in claim 3, wherein the first detector comprises an NMOS photodiode array.

5. The dispersion spectrometer as claimed in claim 1, wherein the wavelength dispersive element is a transmission diffraction grating, and the second detector is configured to register a portion of the incoming radiant energy reflected by the wavelength dispersive element.

6. The dispersion spectrometer as claimed in claim 1, wherein the wavelength dispersive element is a diffraction grating, and the second detector is configured to register a portion of a zero order diffraction intensity of the incoming radiant energy.

7. The dispersion spectrometer as claimed in claim 1, wherein it further comprising:
a controller configured to receive the signal from the second detector and having an electronic storage holding an algorithm for linking the intensity registered by the second detector with an intensity dependent desired value of at least one operational parameter; and
a data processor configured to apply the algorithm to the received signal to determine the intensity dependent desired value and to generate therefrom a control signal to operate the first detector to have varied a relevant operational parameter to the intensity dependent desired value.

8. The dispersion spectrometer as claimed in claim 7, wherein the algorithm held in the electronic storage links the intensity with a desired integration time.

9. The dispersion spectrometer as claimed in claim 7, wherein the algorithm held in the electronic storage links the intensity with a desired gain.
